(19) United States
(12) Patent Application Publication
(10) Pub. No.: US 2011/0131588 A1
(43) Pub. Date: Jun. 2, 2011

(54) SOFTWARE ARCHITECTURE THAT CAN SENSE AND RESPOND TO CONTEXTUAL AND STATE INFORMATION

(75) Inventors: Abdul Allam, Raleigh, NC (US); Keith Jones, Boulder, CO (US); Siva P. Kantamneni, Largo, FL (US)

(73) Assignee: INTERNATIONAL BUSINESS MACHINES CORPORATION, Armonk, NY (US)

(21) Appl. No.: 12/628,627

(22) Filed: Dec. 1, 2009

(51) Int. Cl. G06F 3/00; G06F 13/00

(52) U.S. Cl. 719/318

(57) ABSTRACT

A software architecture that can sense and respond to context and state information is disclosed. The software architecture includes a semantic filter to correlate individual events in an event stream to make the event stream consistent with an ontology. Events in the event stream are substituted with higher order events, resulting in an actionable event stream containing recognizable patterns. Patterns in the actionable event stream are detected and matched with event processing policies to generate an action stream indicating actions to be taken in the real world.

### BACKGROUND

1. Field

The disclosure relates generally to software architecture, and more particularly to a software architecture that can sense and respond to contextual and state information.

2. Description of the Related Art

Event-driven architecture (EDA) is a software architecture pattern promoting the production, consumption of, and reaction to events. An event can be defined as a significant change in state. Computing machinery and sensing devices, like sensors, actuators and controllers, can detect state changes of objects or conditions and create events which can then be processed by a service or system. Event triggers are conditions that result in the creation of an event.

The event-driven architectural pattern may be applied by the design and implementation of applications and systems which transmit events among loosely coupled software components and services. An event-driven system typically consists of event emitters or agents and event consumers or sinks. Sinks have the responsibility of applying a reaction as soon as an event is presented. The reaction might or might not be completely provided by the sink itself. For instance, the sink might have the responsibility to filter, transform and forward the event to another component or it might provide a self contained reaction to such event. The first category of sinks can be based upon traditional components, such as message oriented middleware, while the second category of sinks might require a more appropriate transactional executive framework.

Building applications and systems around an event-driven architecture allows these applications and systems to be constructed in a manner that facilitates more responsiveness, because event driven systems are, by design, more normalized to unpredictable and asynchronous environments. Event drive architectures can complement service-oriented architecture (SOA), because services can be activated by triggers fired on incoming events, which is particularly useful whenever the sink does not provide any self-contained executive.

An event triggered architecture is built on logical layers. It starts with sensing of a fact, its technical representation in the form of an event, and ends with a set of reactions to that event. The first logical layer is the event generator, which senses a fact and represents the fact into an event. A fact can be almost anything that can be sensed. The event can be made of two parts, the event header and the event body. The event header may include information such as event name, timestamp for the event, and type of event. The event body is the part that describes the fact that has happened in reality. An event channel is a mechanism whereby the information from an event generator is transferred to an event engine or sink. The event processing engine is where the event is identified, and the appropriate reaction is selected and executed. Downstream event driven activity is where the consequences of the event are shown. This can be done in many different ways and forms. Depending on the level of automation provided by the event processing engine, the downstream activity might not be required.

There are three general styles of event processing in an event-driven architecture: simple, stream, and complex. The three styles often are used together in a mature event-driven architecture. Simple event processing concerns events that are directly related to specific, measurable changes of condition. In simple event processing, a notable event happens which initiates downstream actions. Simple event processing commonly is used to drive the real-time flow of work, thereby reducing lag time and cost. In event stream processing both ordinary and notable events happen. Ordinary events are screened for notability and streamed to information subscribers. Stream event processing commonly is used to drive the real-time flow of information in and around an enterprise, which enables in-time decision making. Complex event processing allows patterns of simple and ordinary events to be considered to infer that a complex event has occurred. Complex event processing evaluates a confluence of events and then takes action. The events may cross event types and occur over a long period of time. The event correlation may be causal, temporal, or spatial. Complex event processing requires the employment of sophisticated event interpreters, event pattern definition and matching, and correlation techniques. Complex event processing is commonly used to detect and respond to business anomalies, threats, and opportunities.

Semantic event architecture is a predictive architecture based on data. A semantic event architecture can provide suggestions at information architecture level. It can create new forms of data that conform to certain rules.

### SUMMARY

A software architecture that can sense and respond to context and state information is disclosed. A software architecture in accordance with an illustrative embodiment includes a semantic filter to correlate individual events in an event stream to make the event stream consistent with an ontology. Events in the event stream are substituted with higher order events, resulting in an actionable event stream containing recognizable patterns. Patterns in the actionable event stream are detected and matched with event processing policies to generate an action stream indicating actions to be taken in the real world.

A software architecture in accordance with an illustrative embodiment may be implemented as a computer program product including a computer readable storage medium having stored thereon computer program instructions for controlling a data processing system to implement the functions of a software architecture in accordance with an illustrative embodiment. A software architecture in accordance with an illustrative embodiment may be implemented as an apparatus including a processor unit and a memory coupled to the processor unit and having stored therein instructions that are readable by the processor unit for controlling the processor unit to implement the functions of a software architecture in accordance with an illustrative embodiment.

### BRIEF DESCRIPTION OF THE SEVERAL VIEWS OF THE DRAWINGS

FIG. 1 is a block diagram of functional and logical components of a software architecture in accordance with an illustrative embodiment.

FIG. 2 is a block diagram of a data processing system depicted in accordance with an illustrative embodiment.

FIG. 3 is a block diagram illustrating relationships of logical components of an architecture in accordance with an illustrative embodiment.

FIG. 4 is a diagram illustrating event sensing and filtration in an architecture in accordance with an illustrative embodiment.

FIG. 5 is a diagram illustrating an event stream and filtration in an architecture in accordance with an illustrative embodiment.

FIG. 6 is a diagram illustrating gathering context in an architecture in accordance with an illustrative embodiment.

FIG. 7 is a diagram illustrating formation of a complex event stream in an architecture in accordance with an illustrative embodiment.

FIG. 8 is a diagram illustrating detection of state changes in an architecture in accordance with an illustrative embodiment.

FIG. 9 is a diagram illustrating recording event history in an architecture in accordance with an illustrative embodiment.

FIG. 10 is a diagram illustrating detecting and recording event patterns in an architecture in accordance with an illustrative embodiment.

FIG. 11 is a diagram illustrating generating actions according to applicable policies in an architecture in accordance with an illustrative embodiment.

FIG. 12 is a diagram illustrating action filtration and actuation in an architecture in accordance with an illustrative embodiment.

### DETAILED DESCRIPTION

A software architecture that correlates related events, has the ability to predict actions to be taken, and which can execute actions based on rules specific to the situation or context is disclosed. The disclosed architecture can address and solve complex or composite problems. A software architecture in accordance with an illustrative embodiment may find application in many scenarios, applications, and industries, including, but not limited to, building operations, finance, travel, telecommunications, and other industries.

As will be discussed in more detail below, an architecture in accordance with one or more illustrative embodiments provides the following capabilities. The ability to track and filter events, including service requests. The ability to correlate events, including service requests, from multiple sources or multiple event streams. The ability to infer and record state changes. The ability to detect patterns and predict future states based on policies. And the ability to generate actionable commands based on event and/or service request processing policies. The different illustrative embodiments recognize and take into account that these abilities are shortcomings of current event-driven and semantic architectures.

The different illustrative embodiments recognize and take into account that an event-driven architecture addresses dynamic behavior at the application architecture level. In an event-driven architecture, actions are taken based only on a particular event occurring. The event-driven architecture is reactive and does not have the capability to take predictive actions and to adapt itself. It cannot co-relate series of related events, which may be related causally, temporally, or spatially, to take proactive action to solve a composite problem comprising smaller atomic problems. For example, an event-driven architecture is not adapted to predicting failure of a bridge based on events occurring on super and sub-structures of the bridge and arriving concurrently. An event-driven architecture can create a higher level event based on a series of atomic events. However, it can take a predictive action only in the context of those series of atomic events. It cannot predict an abnormal event ahead of time based on history and observed corrective, manual or automated, actions.

The different illustrative embodiments also recognize and take into account that a semantic event architecture cannot provide corrective actions, as it lacks knowledge of the state of the domain. Although semantic event architecture is more advanced than event-driven architecture in predicting a future information state or providing indicators based on rules, it still lacks the ability to take corrective action.

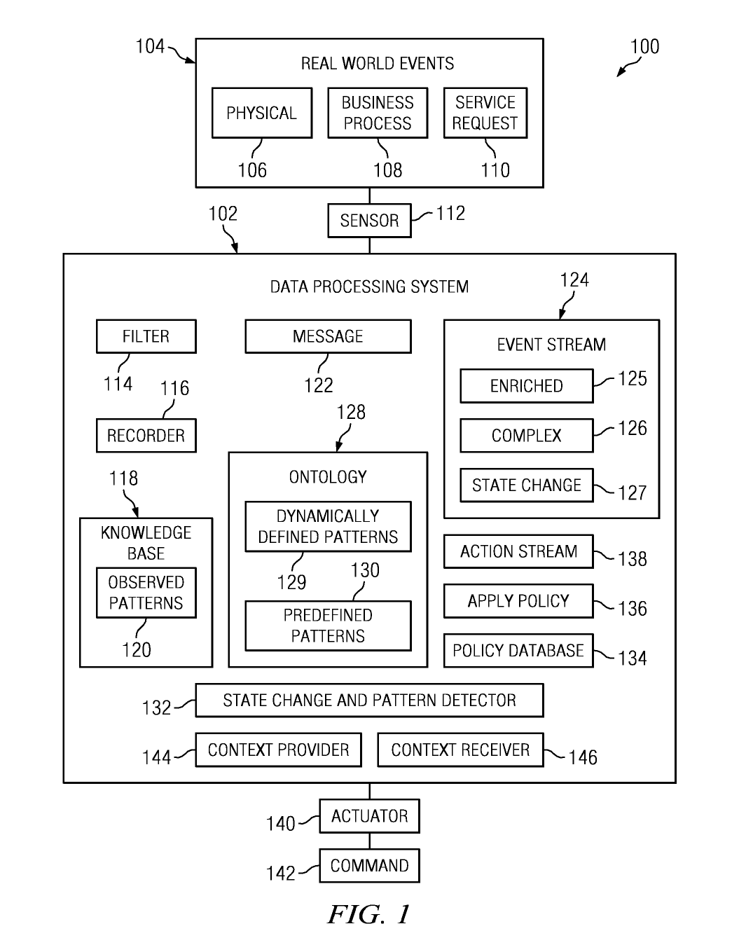

Functional and logical components of software architecture 100 in accordance with an illustrative embodiment are illustrated in FIG. 1. Software architecture 100 in accordance with an illustrative embodiment may be implemented in data processing system 102. Data processing system 102 may include any computer or other programmable device or system or any group or network of computers and/or other devices and/or systems that may be operated separately or together to implement the functions of software architecture 100.

Real world events 104 may include physical events 106, business process events 108, and/or service request events 110. Physical events 106 may include detectable changes in a physical or temporal state of an object or signal. For example, physical events 106 may include detectable changes in position, state, or characteristics of an object or space, such as temperature changes. Physical events 106 also may include changes in the state or characteristics of a signal, such as the presence, absence, frequency, amplitude, or other characteristics of a signal. Business process events 108 and service request events 110 typically reflect commercial or other activities of individuals or systems that may be captured in a computer or other system. Throughout this application, including in the appended claims, and unless stated otherwise, the term “events” should be understood to refer to at least these various different kinds of real world events 104, including service requests 110.

Real world events 104 are detected or sensed by sensors 112. Sensors 112 capture real world events 104 and convert those events into a form that can be understood and processed in data processing system 102 using architecture 100 in accordance with an illustrative embodiment. The implementation of sensors 112 will depend on the nature of real world events 104 to be detected or sensed. For example, for physical events 106, sensors 112 may include mechanical, electrical, and/or optical sensors that detect a physical event and that output an electronic signal in response thereto that can be transmitted to and processed by data processing system 102. For business process 108 and service request 110 events, sensors 112 may include computer software programs for detecting such events in databases and/or in other systems and for passing messages indicating the occurrence of such events to data processing system 112. In general, sensors 112 may be embedded in hardware, firmware, or software systems. Sensors 112 may be implemented either wholly or partially separate from data processing system 102, and may include the ability to transmit sensed real world events 104 to data processing system 102. Alternatively, sensors 112 may be implemented either wholly or partially within data processing system 102.

Real world events 104 are converted by sensor 112 into data messages 122 for processing in data processing system 102. In accordance with an illustrative embodiment, messages 122 are filtered using filter 114 to make the events in event stream 124 consistent with ontology 128.

In accordance with an illustrative embodiment, event stream 124 is processed to substitute events in event stream 124 with higher order events, such as enriched events 125, complex events 126, and state change events 127. These higher order events may be generated based on event patterns defined in ontology 128, including dynamically defined patterns 129 and predefined patterns 130, and patterns stored in knowledge base 118. Recorder 116 may be employed to record observed patterns 120 from event stream 124 into knowledge base 118. Context provider 144 and context receiver 146 may be employed to determine the context of events in event stream 124 to generate enriched events 125.

State change and pattern detector 132 is used to detect the patterns in event stream 124. Policies from policy database 134 are applied to the detected patterns in event stream 124 by an apply policy function 136 to generate action stream 138 of actions to be implemented. Actions from action stream 138 are provided to actuator 140 to implement commands 142 or actions in the real world.

The illustration of FIG. 1 is not meant to imply physical or architectural limitations to the manner in which different advantageous embodiments may be implemented. Other components in addition to and/or in place of the ones illustrated may be used. Some components may be unnecessary in some advantageous embodiments. Also, the blocks are presented to illustrate some functional components. One or more of these blocks may be combined and/or divided into different blocks when implemented in different advantageous embodiments.

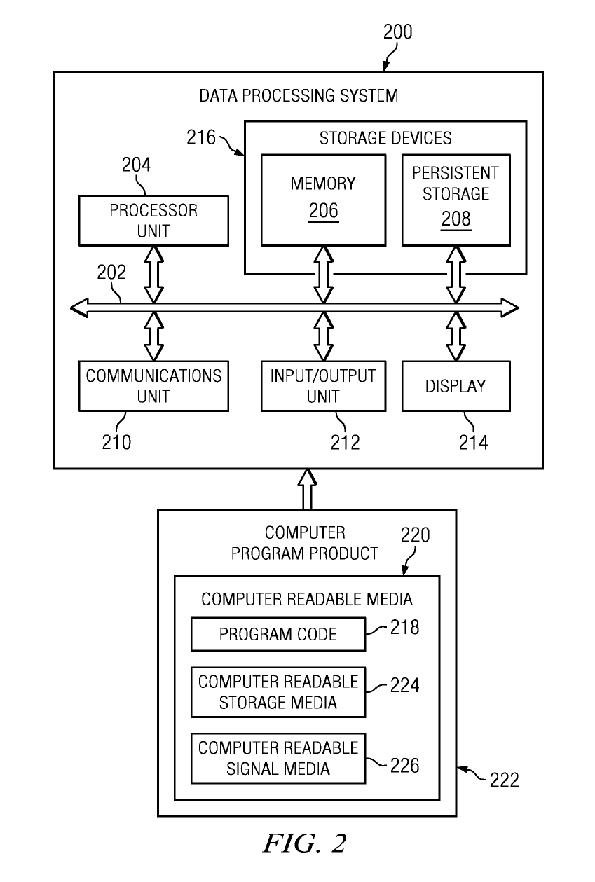

Turning now to FIG. 2, a diagram of a data processing system 200 is depicted in accordance with an illustrative embodiment. In this example, data processing system 200 is an example of one implementation of data processing system 102 in FIG. 1. In this illustrative example, data processing system 200 includes communications fabric 202, which provides communications between processor unit 204, memory 206, persistent storage 208, communications unit 210, input/output (I/O) unit 212, and display 214.

Processor unit 204 serves to execute instructions for software that may be loaded into memory 206. Processor unit 204 may be a set of one or more processors or may be a multi-processor core, depending on the particular implementation. Further, processor unit 204 may be implemented using one or more heterogeneous processor systems, in which a main processor is present with secondary processors on a single chip. As another illustrative example, processor unit 204 may be a symmetric multi-processor system containing multiple processors of the same type.

Memory 206 and persistent storage 208 are examples of storage devices 216. A storage device is any piece of hardware that is capable of storing information, such as, for example, without limitation, data, program code in functional form, and/or other suitable information either on a temporary basis and/or a permanent basis. Memory 206, in these examples, may be, for example, a random access memory, or any other suitable volatile or non-volatile storage device. Persistent storage 208 may take various forms, depending on the particular implementation. For example, persistent storage 208 may contain one or more components or devices. For example, persistent storage 208 may be a hard drive, a flash memory, a rewritable optical disk, a rewritable magnetic tape, or some combination of the above. The media used by persistent storage 208 may be removable. For example, a removable hard drive may be used for persistent storage 208.

Communications unit 210, in these examples, provides for communication with other data processing systems or devices. In these examples, communications unit 210 is a network interface card. Communications unit 210 may provide communications through the use of either or both physical and wireless communications links.

Input/output unit 212 allows for the input and output of data with other devices that may be connected to data processing system 200. For example, input/output unit 212 may provide a connection for user input through a keyboard, a mouse, and/or some other suitable input device. Further, input/output unit 212 may send output to a printer. Display 214 provides a mechanism to display information to a user.

Instructions for the operating system, applications, and/or programs may be located in storage devices 216, which are in communication with processor unit 204 through communications fabric 202. In these illustrative examples, the instructions are in a functional form on persistent storage 208. These instructions may be loaded into memory 206 in order to be run by processor unit 204. The processes of the different embodiments may be performed by processor unit 204 using computer implemented instructions, which may be located in a memory, such as memory 206.

These instructions are referred to as program code, computer usable program code, or computer readable program code that may be read and run by a processor in processor unit 204. The program code, in the different embodiments, may be embodied on different physical or computer readable storage media, such as memory 206 or persistent storage 208.

Program code 218 is located in a functional form on computer readable media 220 that is selectively removable and may be loaded onto or transferred to data processing system 200 to be run by processor unit 204. Program code 218 and computer readable media 220 form computer program product 222. In one example, computer readable media 220 may be computer readable storage media 224 or computer readable signal media 226. Computer readable storage media 224 may include, for example, an optical or magnetic disc that is inserted or placed into a drive or other device that is part of persistent storage 208 for transfer onto a storage device, such as a hard drive, that is part of persistent storage 208. Computer readable storage media 224 also may take the form of a persistent storage, such as a hard drive, a thumb drive, or a flash memory that is connected to data processing system 200. In some instances, computer readable storage media 224 may not be removable from data processing system 200.

Alternatively, program code 218 may be transferred to data processing system 200 using computer readable signal media 226. Computer readable signal media 226 may be, for example, a propagated data signal containing program code 218. For example, computer readable signal media 226 may be an electro-magnetic signal, an optical signal, and/or any other suitable type of signal. These signals may be transmitted over communications links, such as wireless communications links, an optical fiber cable, a coaxial cable, a wire, and/or any other suitable type of communications link. In other words, the communications link and/or the connection may be physical or wireless in the illustrative examples.

In some illustrative embodiments, program code 218 may be downloaded over a network to persistent storage 208 from another device or data processing system through computer readable signal media 226 for use within data processing system 200. For instance, program code stored in a computer readable storage media in a server data processing system may be downloaded over a network from the server to data processing system 200. The data processing system providing program code 218 may be a server computer, a client computer, or some other device capable of storing and transmitting program code 218.

The different components illustrated for data processing system 200 are not meant to provide architectural limitations to the manner in which different embodiments may be implemented. The different illustrative embodiments may be implemented in a data processing system including components in addition to or in place of those illustrated for data processing system 200. Other components shown in FIG. 2 can be varied from the illustrative examples shown. The different embodiments may be implemented using any hardware device or system capable of executing program code. As one example, data processing system 200 may include organic components integrated with inorganic components and/or may be comprised entirely of organic components excluding a human being. For example, a storage device may be comprised of an organic semiconductor.

As another example, a storage device in data processing system 200 is any hardware apparatus that may store data. Memory 206, persistent storage 208, and computer readable media 220 are examples of storage devices in a tangible form.

In another example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 206 or a cache such as found in an interface and memory controller hub that may be present in communications fabric 202.

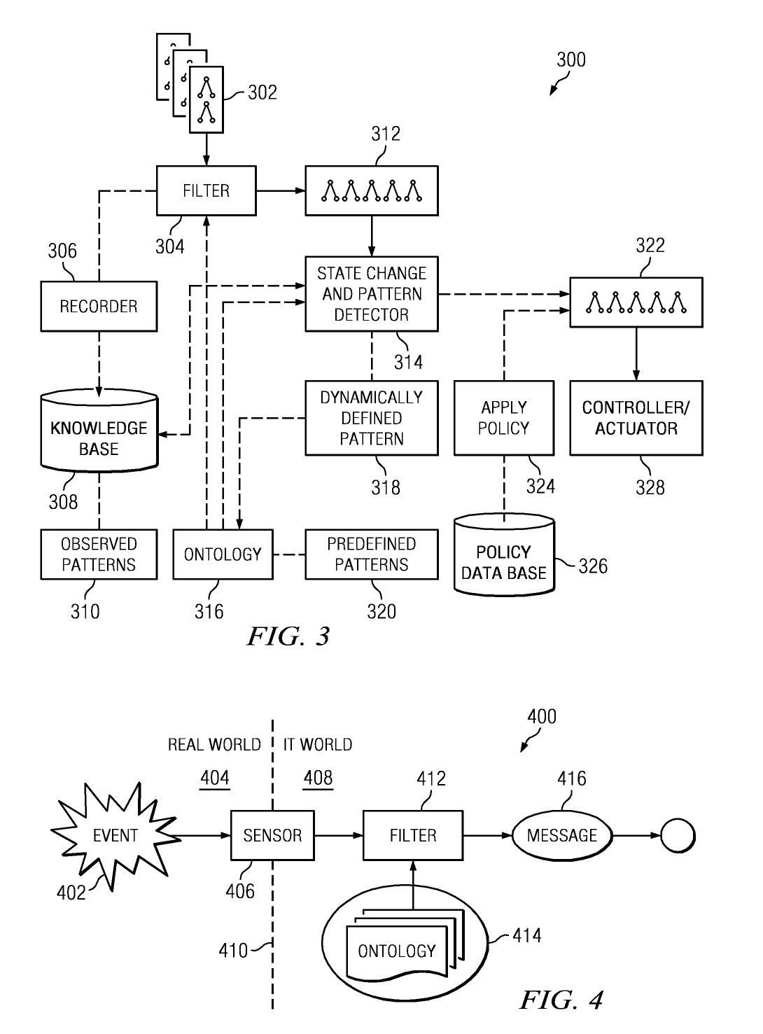

Relationships of logical components of a software architecture 300 in accordance with an illustrative embodiment are illustrated in FIG. 3. In this example, software architecture 300 is an example of software architecture 100 implemented in data processing system 102 in FIG. 1.

In accordance with an illustrative embodiment, events 302, including service requests, that have been translated to event data message as described herein, are provided as inputs to filter component 304. Events 302 may be from various heterogeneous sources. For example, service request events 302 may be from both service consuming and service providing entities. Service consuming entities may include entities that generate service requests. Service providing entities may include entities that provide services in response to service requests.

Filter component 304 employs ontology metadata 316 for semantic filtering initially to screen out non-relevant events 302, including non relevant service requests. Ontology metadata 316 represents a particular theory about reality and thus about what events 302 mean. Ontology 316 thus provides a model for describing the real world. Ontology 316 may be implemented as a representation of a set of concepts within a domain and the relationships between those concepts. Thus, ontology 316 metadata may consist of a set of types of events, properties of those types, and relationship types. Predefined patterns 320, such as events in context and state changes, are part of the ontological specification. In accordance with an illustrative embodiment, semantic filtering is filtering of events 302 based on their meaning with respect to ontology 316. Non-relative events are events 302 that have no relevant meaning within ontology 316. Semantic filtering ensures consistency within the constraints of domain ontology 316. Thus, in accordance with an illustrative embodiment, events 302 captured by sensors get transformed or translated by filter 304 according to first-order logic or rules defined in ontology 316. This filtration results in semantically correct but unrelated event data streams 312. Thus, an architecture in accordance with an illustrative embodiment provides the ability to track and filter events, such as service requests, based on ontology 316 metadata.

In accordance with an illustrative embodiment, several streams of event data from sets of related but different sensors are correlated, combined, and filtered to ensure consistency within the constraints of expanded domain ontology 316. Detection and recognition of events, such as service requests, within the context, may result in new enriched events being injected into an event stream for later processing. In accordance with an illustrative embodiment, such an event stream may be called an enriched event stream. Filtering of these events results not only in a semantically correct event or data stream, but also results in complex and enriched event or data streams. Detection and recognition of events within context may result in new, second order, enriched events being injected into an event stream for later processing. Thus, an architecture in accordance with an illustrative embodiment provides the ability to correlate events, such as service requests, from multiple sources or event streams.

Event data from single or multiple sources in any event stream are recorded by recorder function 306 to build up and maintain current knowledge base 308. Knowledge base 308 may be initiated or primed with initial state data defined by ontology 316 which contains relevant data specific to domains. Knowledge base 308 captures the specific relationship between events that results in detection of a state change. Due to this relationship between events, when values of certain event data types are taken in combination with others, possibly from different domains, the state of key resources can be determined. Details previously recorded in knowledge base 308 may be used in the detection of state change information. Detection of state changes may result in new, second order, events being injected into an event stream for later processing. Detection of state changes has the potential to reduce the total volume of event data flowing in an architecture by substitution of original events with higher level “smarter” events. Thus, an architecture in accordance with an illustrative embodiment provides the ability to infer and record state changes.

As discussed above, ontology 316 includes predefined patterns, such as events in context and state changes. In accordance with an illustrative embodiment, state change and pattern detector function 314 dynamically detects patterns within event data stream 312. The detection of such patterns may give rise to new second and higher order events, to be handled later. The detection of such patterns also may be used to extend ontological specification 316 for later use. Thus, in accordance with an illustrative embodiment, ontology may be updated with dynamically defined patterns 318 that are discovered by state change and pattern detector 314. Knowledge base 308 contains known or observed 310 patterns that have been instantiated at least once. Thus, knowledge base 308 includes both predefined and dynamically detected patterns. State change and pattern detector 314 uses the content of both knowledge base 308 and ontology 316 to generate actionable related events 322, such as services. Thus, an architecture in accordance with an illustrative embodiment provides the ability to detect patterns and predict a future state based on policies.

In accordance with an illustrative embodiment, policies are applied to actionable related events 322 by apply policy function 324 to generate action signals that are provided to controller/actuator 328 to implement an action in the real world. Polices employed by function 324 may be provided in policy data base 326. Policy data base 326 may be implemented as a separate component, as illustrated in FIG. 3, or within ontology 316. Preferably the policies applied by function 324 are defined to facilitate generation of actions from detected events or patterns using the same vocabulary relevant to targeted domains as employed by ontology 316. In accordance with an illustrative embodiment, matching patterns represented by actionable related events 322 to policies encapsulates the translation of patterns detected into necessary actions to be actuated in the real world. Appropriate actions are generated when patterns are recognized or when individual event data is processed within an architecture in accordance with an illustrative embodiment. Thus, an architecture in accordance with an illustrative embodiment provides the ability to generate actionable commands using event processing policies.

The combined application of an architectural design based upon events, services, and semantics in accordance with an illustrative embodiment is described now with reference to a simple “building operations” scenario. As discussed above, an architecture in accordance with an illustrative embodiment may be applied in similar fashion to other scenarios in other applications and/or industries.

An example of event sensing and filtration 400 in accordance with an illustrative embodiment is illustrated in FIG. 4. In a smart building, many events 402 occur in real world 404. In accordance with an illustrative embodiment, these events are detected by sensors 406 in and around the building. As discussed above, different types of events 402 may require different types of sensors 406. In general, sensors 406 may be embedded in hardware, firmware, or software systems. Sensors 406 transform events 402 in real world 404 into event data messages 416 in information technology world 408. Thus, sensors 406 bridge line 410 between real world 404 and information technology world 408.

In accordance with an illustrative embodiment, data provided by sensors 406 is passed through semantic filters 412. Filters 412 ensure consistency of event data messages 416 within the constraints of domain ontology 414. In this case, the domain of ontology 414 may be building operations. Thus, in accordance with an illustrative embodiment, events 402 captured by sensors 406 are transformed or translated by filter 412 according to first-order logic or rules defined in ontology 414.

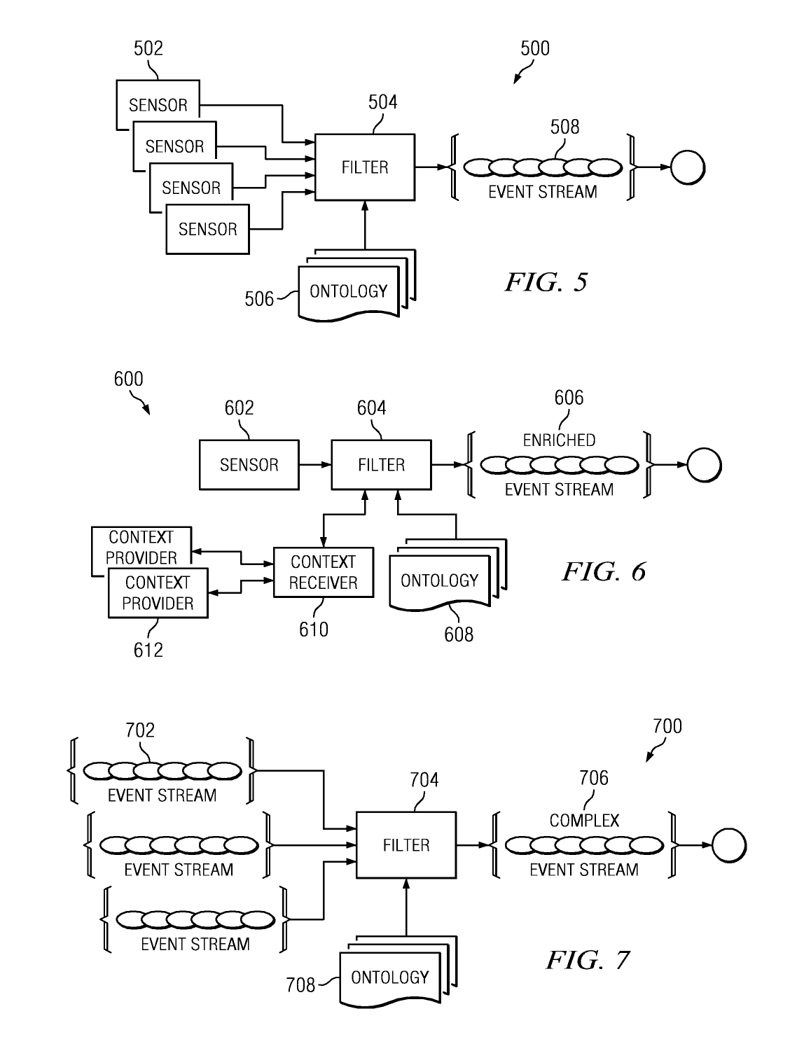

An example of event streams and filtration 500 in accordance with an illustrative embodiment is illustrated in FIG. 5. Many different sensors 502 may be employed to detect real world events in a large system, such as a smart building. Each of the many sensors 502 may produce data messages relating to events of a particular resource or a particular class of resources in the system. In accordance with an illustrative embodiment, event data messages from related sources may be routed and filtered through a single filter 504 to ensure consistency within the constraints of an expanded domain ontology 506 that also defines relationships between several event types. Thus, in accordance with an illustrative embodiment, data captured by different but related sensors 502 may be transformed or translated by filter 504 according to first-order logic defined in appropriate domain ontology 506. This filtration results in semantically correct event data streams 508.

An example of gathering context 600 in accordance with an illustrative embodiment is illustrated in FIG. 6. Certain relationships within ontology 608 may define the notion of a context by recognizing that values of particular event data types from sensor 602, when taken in combination with other values from different sensors, define the context within which an event has occurred. In accordance with an illustrative embodiment, detection and recognition of events within context by semantic filtering 604 based on ontology 608 may result in new, second order, enriched events being injected into an event stream for later processing. Such an event stream may be called enriched event stream 606.

In some scenarios in accordance with an illustrative embodiment, contextual information may be gathered by context receivers 610 that send service requests to context providers 612 that are known to be related to arriving events passing through filter 604. In this case, filtering 604 may be based on the context provided by context receiver 610, rather than on context provided by ontology 608. This alternative approach to gathering context also may result in enriched event streams 606.

Detection of events in context can result in a reduction in the total volume of event data flowing in an architecture in accordance with an illustrative embodiment. By detection of events in context, originally detected events can be replaced with higher level “smarter” events.

An example of creating complex event streams 700 in accordance with an illustrative embodiment is illustrated in FIG. 7. In accordance with an illustrative embodiment, several streams 702 of event data, such as from sets of related but different sensors, may be combined and filtered using filter 704 to ensure consistency within the constraints of further expanded domain ontology 708. Such expanded ontology 708 describes possible relationships between the many event types that may be found in event streams 702. Some of these relationships may be complex. Data captured within event streams 702 may be transformed or translated by filter 704 according to first-order logic defined in appropriate domain ontology 708. This filter action may result in complex event stream 706, including enriched, but semantically correct event data.

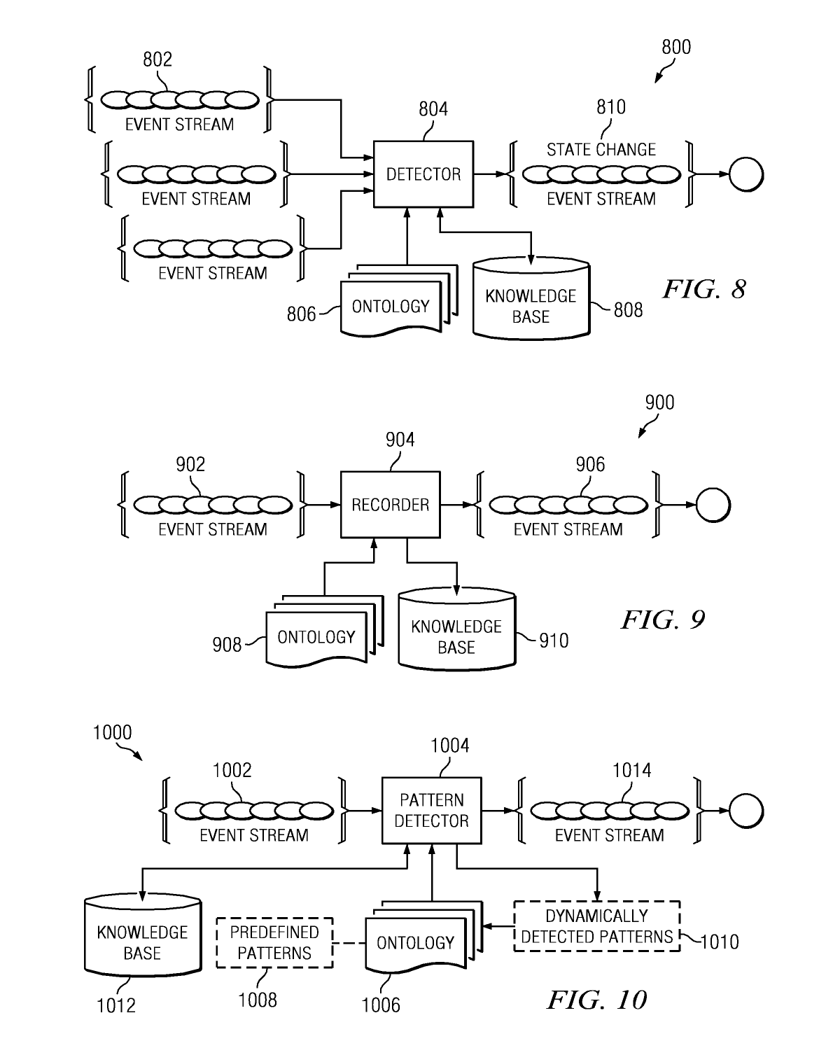

An example of detecting state changes 800 in accordance with an illustrative embodiment is illustrated in FIG. 8. Certain relationships within ontology 806 may define the notion of state. The notion of state recognizes that values of certain event data types, when taken in combination with others, possibly from different domains, define the state of certain systems, such as key building resources. State changes may be detected by detector 804 from event data streams 802 by applying the relationships in ontology 806 that define states. Detection of state change information may require details previously recorded in knowledge base 808 or details previously recorded by smart sensors and included in event data stream 802. Detection 804 of state changes may result in new, second order, events being injected into state change event streams 810 for later processing. Like detection of events in context, detection of state changes can result in a reduction in the total volume of event data flowing in an architecture in accordance with an illustrative embodiment by substitution of originally detected events with higher level “smarter” events.

An example of recording event history 900 in accordance with an illustrative embodiment is illustrated in FIG. 9. In accordance with an illustrative embodiment, event data from single or multiple sources in event stream 902 and 906 may be recorded by recorder 904 to build up and maintain current knowledge base 910. Certain more sophisticated sensor sources may include relevant historical data when emitting events. Domain ontology 908, containing relevant metadata, may be used by recorder 904 to decide which data to include in historical records in knowledge base 910. As discussed above, knowledge base 910 preferably is initialized or primed with initial state data which also is defined within ontology 908.

Detecting and recording patterns 1000 in accordance with an illustrative embodiment is illustrated in FIG. 10. Events-in-context and state-changes are two examples of patterns that may be detected in event streams 1002 by pattern detector 1004 in accordance with an illustrative embodiment. Many more and different kinds of patterns may be detected within an architecture in accordance with an illustrative embodiment. The patterns to be detected are defined within domain ontology 1006. Patterns may be abstract, involving combinations of singular event types, event streams, and other patterns. In accordance with an illustrative embodiment, patterns may be defined within domain ontology 1006 so that they may be detected as soon as they occur, or shortly thereafter, in the information technology world. Detection of patterns by pattern detector 1004 may result in the generation of new, second order, events in event stream 1014 to be handled later. In accordance with an illustrative embodiment, instances of detected patterns in event streams 1002 are stored as observed patterns in knowledge base 1012.

A distinction may be drawn between predefined patterns 1008 defined within ontology 1006 and dynamically detected patterns 1010 that are dynamically detected within event streams 1002 and added to domain ontology 1006 by pattern detector 1004. Both predefined patterns 1008 and dynamically detected patterns 1010 in domain ontology 1006 may be used by pattern detector 1004 to detect instances of patterns in event streams 1002 that are recorded in knowledge base 1012. The distinction between predefined patterns 1008 and dynamically detected patterns 1010 allows for the possibility that, while certain patterns may be known when an architecture in accordance with an illustrative embodiment is defined, other patterns may be dynamically discovered after operational deployment. Thus, in accordance with an illustrative embodiment, new patterns may be dynamically discovered by pattern detector 1004, resulting in extensions to domain ontology 1006 for later use. Detection of previously unseen patterns by pattern detector 1004 may utilize abstraction to identify the new patterns that may be recorded as dynamically detected patterns 1010 in domain ontology 1006. Dynamically detected patterns 1010 stored in domain ontology 1006 may be used by pattern detector 1004 to detect instances of such patterns in event stream 1002, should they re-occur. Thus, an architecture in accordance with an illustrative embodiment may learn to expect new situations, characterized by events emitted, by using this mechanism.

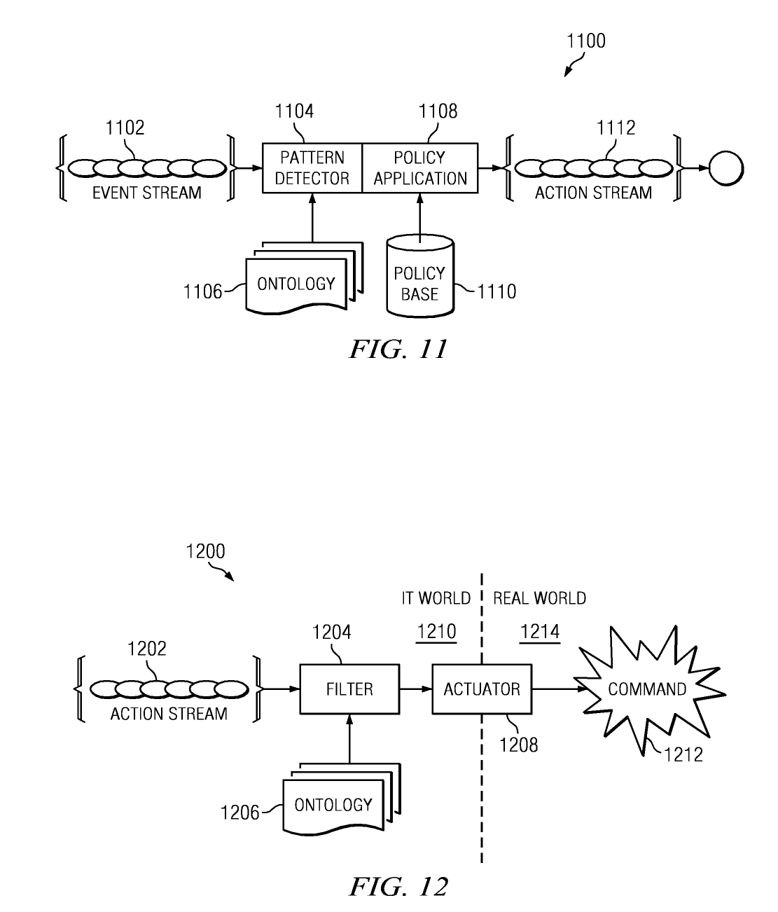

An example of generating actions according to applicable policies 1100 in accordance with an illustrative embodiment is illustrated in FIG. 11. As discussed above, in accordance with an illustrative embodiment, individual events and streams of events are first made consistent using semantic filters. Successive substitution of first-order events with second or higher order events results in event streams 1102 that may contain recognizable and actionable patterns. In accordance with an illustrative embodiment, each pattern, no matter how simple or complex, becomes actionable once matched with event processing policies. In accordance with an illustrative embodiment, matching event patterns with policies encapsulates the translation of patterns detected into necessary actions to be actuated in the real world. Each pattern detected may result in many such actions as required to make changes, for example, to building resources, in the architecture implementation being discussed.

In accordance with an illustrative embodiment, appropriate actions are generated when patterns in event stream 1102 are recognized by pattern detector 1104 or when individual event data is processed within the architecture. The correspondence between patterns and event processing policies is obtained from domain ontology 1106. This may be a multi-stage process, for example, determining context, recognizing state changes, recognizing patterns by pattern detector 1104, applying policies 1108, and using inference to reason responses to generate action service request messages targeted for real world systems, such as real world building resource controllers. The generated action service request messages form action stream 1112.

Policies employed for policy application 1108 may be stored in separate policy database 1110 or as part of domain ontology 1106. In accordance with an illustrative embodiment, the specific actions to be taken in response to the detection of specific patterns in actionable event stream 1102 may be defined in domain ontology 1106. Domain ontology 1106, which may include a set of related ontologies, renders the definition of related events, service requests, contexts, states, streams, patterns, policies and actions consistent with a real world domain. When new patterns are detected by pattern detector 1104, new policies also may be needed. In accordance with an illustrative embodiment, such new policies may be determined dynamically by application of appropriate strategies, such as manual intervention, trial and error, and Monte Carlo simulation.

An example of action filtration and actuation 1200 in accordance with an illustrative embodiment is illustrated in FIG. 12. In accordance with an illustrative embodiment, action messages in action stream 1202 may be transformed or translated by filters 1204 in accordance with first-order logic in ontology 1206 and passed to actuators 1208 or controllers. Actuators 1208 translate the action messages in information technology world 1210 into commands 1212 for action in real world 1214. For example, actuators 1208 may include controllers that make adjustments to smart building resources in real world 1214 in response to the action messages. Different building resources, and different real world commands 1212 or actions in general, may require different actuators 1208 or controllers. For example, actuators 1208 may be implemented as service providers.

Commands 1212, such as service requests, that are implemented in real world 1214 by actuators 1208 or controllers, may, in turn, result in real world events. Such real world events may be detected or sensed, and received back into an event data stream in an architecture in accordance with an illustrative embodiment, in the manner described above. Thus, an architecture in accordance with an illustrative embodiment provides for recursive application within a domain.

As discussed above, an architecture in accordance with an illustrative embodiment may be applied in a wide variety of applications, scenarios and industries. Only two of many possible other applications of an architecture in accordance with an illustrative embodiment, an aircraft scenario and a financial market scenario, are presented as further examples.

Most aircraft are equipped with sensors for monitoring critical components that alert pilots on a regular basis during the flight. However, this monitoring of events currently is limited to in-flight events, due to current communication architecture constraints. By adapting an architecture in accordance with an illustrative embodiment, this monitoring can be extended to a central location and across all flights in motion. By leveraging event processing in accordance with an illustrative embodiment with maintenance history of all aircraft, including their types, along with crash history, a potential catastrophic event, such as a crash due to icing conditions, may be detected by applying patterns in accordance with an illustrative embodiment coupled with historical data by creating a composite event from wings, rudder, and flight operating mode, auto pilot or manual, events. Avoidable crashes have occurred, such as due to icing conditions, because pilots must manually process such interrelated events and do not have access to historical events data. A system in accordance with an illustrative embodiment is capable of forewarning pilots of potential icing situations and of warning pilots not to engage autopilot mode during landing in such situations.

The state of the global stock market in 2009 is widely attributed to the mortgage crisis which, in turn, was caused by bad debt management and poor monitoring and risk control mechanisms in place. Even though sophisticated monitoring currently is in place for mortgage debts, bonds, and securities individually, a mechanism to correlate events related to mortgages, bonds, and securities and to understand the dependencies among derivatives is lacking. By leveraging an architecture in accordance with an illustrative embodiment, a composite event stream can be created that can correlate events from mortgage, bond, and security markets worldwide. By the use of patterns in accordance with an illustrative embodiment coupled with historical indicators, the true value of securities considering debt at the source level, such as mortgage debt, can be determined and stock managers alerted.

Thus, a software architecture that can sense and respond to contextual and state information is provided. One or more of the illustrative embodiments provides the following capabilities. The ability to track and filter events, including service requests. The ability to correlate events, including service requests, from multiple sources or multiple event streams. The ability to infer and record state changes. The ability to detect patterns and predict future states based on policies. And the ability to generate actionable commands, such as event and/or service request processing policies.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the in the different depicted embodiments illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Also, other blocks may be added in addition to the illustrated blocks in a flowchart or block diagram. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and explanation, but is not intended to be exhaustive or to limit the invention in the form disclosed. Many modifications and variations will be apparent to those of ordinary skill in the art without departing from the scope and spirit of the invention. The illustrative embodiments were chosen and described in order to best explain the principles of the invention and the practical application, and to enable others of ordinary skill in the art to understand the invention for various embodiments with various modifications as are suited to the particular use contemplated.

What is claimed is:

1. A software architecture, comprising:
a semantic filter configured to correlate individual events in an event stream to make the event stream consistent with an ontology;
a filter configured to substitute events in the event stream with higher order events resulting in an actionable event stream containing recognizable patterns;
a pattern detector configured to detect the patterns in the actionable event stream; and
a policy application configured to match patterns in the actionable event stream with event processing policies to generate an action stream indicating actions to be taken in the real world.

2. The software architecture of claim 1, wherein the individual events in the event stream include data messages received from sensors configured to detect corresponding real world events, and wherein the real world events include events selected from the group of real world events consisting of physical events, business process events, and service requests.

3. The software architecture of claim 1, wherein the filter configured to substitute events in the event stream is configured to detect events in the event stream in a context, wherein the context is defined by values of event data types of the events in the event stream taken in combination with other values from different event streams, and is configured to generate enriched events from the events detected in context and to inject the enriched events into the actionable event stream.

4. The software architecture of claim 1, wherein the filter configured to substitute events in the event stream is configured to combine events from a plurality of event streams to generate complex events and to inject the complex events into the actionable event stream.

5. The software architecture of claim 1, wherein the filter configured to substitute events in the event stream includes a detector configured to detect a state change in a system from events in the event stream and is configured to generate state change events in response to the detection of the state change and to inject the state change events into the actionable event stream.

6. The software architecture of claim 1, wherein the pattern detector is configured to detect patterns in the actionable event stream that are predefined within the ontology and that are dynamically detected within the actionable event stream.

7. The software architecture of claim 1 further comprising a knowledge base and a recorder configured to record patterns detected in the actionable event stream in the knowledge base.

8. A computer program product including a computer readable storage medium having stored thereon computer program instructions for controlling a data processing system to implement a software architecture, comprising:
computer program instructions stored on the computer readable storage medium to filter individual events in an event stream to make the event stream consistent with an ontology;
computer program instructions stored on the computer readable storage medium to substitute events in the event stream with higher order events resulting in an actionable event stream containing recognizable patterns;
computer program instructions stored on the computer readable storage medium to detect the patterns in the actionable event stream; and
computer program instructions stored on the computer readable storage medium to match patterns in the actionable event stream with event processing policies to generate an action stream indicating actions to be taken in the real world.

9. The computer program product of claim 8, wherein the individual events in the event stream include data messages received from sensors configured to detect corresponding real world events, and wherein the real world events include events selected from the group of real world events consisting of physical events, business process events, and service requests.

10. The computer program product of claim 8 further comprising computer program instructions stored on the computer readable storage medium to detect events in the event stream in a context, wherein the context is defined by values of event data types of the events in the event stream taken in combination with other values from different event streams, and computer program instructions stored on the computer readable storage medium to generate enriched events from the events detected in context and to inject the enriched events into the actionable event stream.

11. The computer program product of claim 8 further comprising computer program instructions stored on the computer readable storage medium to combine events from a plurality of event streams to generate complex events and to inject the complex events into the actionable event stream.

12. The computer program product of claim 8 further comprising computer program instructions stored on the computer readable storage medium to detect a state change in a system from events in the event stream and to generate state change events in response to the detection of the state change and to inject the state change events into the actionable event stream.

13. The computer program product of claim 8 further comprising computer program instructions stored on the computer readable storage medium to detect patterns in the actionable event stream that are predefined within the ontology and that are dynamically detected within the actionable event stream.

14. The computer program product of claim 8 further comprising computer program instructions stored on the computer readable storage medium to record patterns detected in the actionable event stream in a knowledge base.

15. A method implemented in a data processing system, comprising:
filtering individual events in an event stream to make the event stream consistent with an ontology;
substituting events in the event stream with higher order events resulting in an actionable event stream containing recognizable patterns;
detecting the patterns in the actionable event stream; and
matching patterns in the actionable event stream with event processing policies to generate an action stream indicating actions to be taken in the real world.

16. The method of claim 15, wherein the individual events in the event stream include data messages received from sensors configured to detect corresponding real world events, and wherein the real world events include events selected from the group of real world events consisting of physical events, business process events, and service requests.

17. The method of claim 15, wherein substituting events in the event stream includes detecting events in the event stream in a context, wherein the context is defined by values of event data types of the events in the event stream taken in combination with other values from different event streams, generating enriched events from the events detected in context, and injecting the enriched events into the actionable event stream.

18. The method of claim 15, wherein substituting events in the event stream includes combining events from a plurality of event streams to generate complex events and injecting the complex events into the actionable event stream.

19. The method of claim 15, wherein substituting events in the event stream includes detecting a state change in a system from events in the event stream, generating state change events in response to the detection of the state change, and injecting the state change events into the actionable event stream.

20. The method of claim 15, wherein detecting the patterns includes detecting patterns in the actionable event stream that are predefined within the ontology and that are dynamically detected within the actionable event stream.
